(19) United States
(12) Patent Application Publication
(10) Pub. No.: US 2025/0180846 A1
(43) Pub. Date: Jun. 5, 2025

(54) CABLE ADAPTER STRUCTURALLY CONFIGURED TO AUGMENT A CABLE DIAMETER TO ENHANCE ATTACHMENT WITH A COMPONENT

(71) Applicant: BELDEN CANADA ULC, SAINT-LAURENT (CA)

(72) Inventors: Massimo CARBONI, Montreal (CA); Moise LEVY, LAVAL (CA)

(73) Assignee: BELDEN CANADA ULC, SAINT-LAURENT, QC (CA)

(21) Appl. No.: 18/966,016

(22) Filed: Dec. 2, 2024

Related U.S. Application Data
(60) Provisional application No. 63/604,583, filed on Nov. 30, 2023.

(51) Int. Cl. G02B 6/44; H02G 3/04

(52) U.S. Cl. CPC G02B 6/4459; H02G 3/0437

(57) ABSTRACT

A cable adapter may include a body portion configured to include a cable receiving portion and a cable gripping portion. The cable receiving portion may include a longitudinal bore extending from a first end of the body portion to a second end of the body portion, and the cable receiving portion may be configured to receive a portion of a cable from a lateral side of the body portion. The body portion may be structurally configured to engage a grooved portion of an outer surface of a jacket of a cable, and wherein the body portion is configured to receive a gripping portion of a component of a telecommunications network, such that the body portion is structurally configured to augment an outer diameter of a cable received in the cable receiving portion such that the cable is configured to be coupled with the component at an opening of the component having a diameter that is larger than an outer diameter of the cable so as to provide enhanced attachment of the cable to the component.

### CROSS-REFERENCE TO RELATED APPLICATION

This application claims the benefit of U.S. Provisional Application No. 63/604,583, filed Nov. 30, 2023, which is currently pending, the disclosure of which is hereby incorporated by reference herein in its entirety.

### TECHNICAL FIELD

The present disclosure is directed to a cable adapter and, more particularly, to a cable adapter structurally configured to augment a cable diameter to enhance attachment with a component, for example, a component of a fiber optic network.

### BACKGROUND

Increased use wired and wireless signal pathway by commercial and residential consumers has heightened the number of signal network components working in conjunction. While physical mounting of network components has been facilitated, in the past, with static equipment that correspond with designated component orientations and positions. Such static component configurations can provide practical functionality for some equipment and network connectivity, but can be limited in mounting options that reduce the ability to utilize equipment in manners that optimize the capabilities of some network equipment.

The lack of physical mounting options for some network equipment has emphasized innovation in mounting systems that provide diverse equipment positioning and orientations. Accordingly, various embodiments are directed to network equipment mounting systems that provide a variety of equipment configurations.

Therefore, it may be desirable to provide a cable adapter structurally configured to augment a cable diameter to enhance attachment with a component, for example, a component of a fiber optic network. It may be desirable to provide an adapter structurally configured to augment a diameter of a fiber optic cable, for example, a grooved fiber optic cable, from a first outer diameter to a second outer diameter, which is greater than the first outer diameter, such that the fiber optic cable is structurally configured to be securely attached with a component, such as a fiber entry box or other cable enclosure, that is configured to hold a cable having an outer diameter that is at least as large as the second outer diameter. In some aspects, it may be desirable to provide an adapter that is structurally configured to prevent axial movement of a cable relative to a component in response to a pulling force on the cable.

### SUMMARY

According to various aspects of the disclosure, a cable adapter may include a body portion configured to include a cable receiving portion, a cable gripping portion, and a component engaging portion. The cable receiving portion may include a U-shaped longitudinal bore extending from a first end of the body portion to a second end of the body portion such that the body portion may have a substantially C-shaped cross-sectional shape, and the cable receiving portion may be configured to receive a portion of a cable from a lateral side of the body portion such that the cable is permitted to extend beyond at least one of the first end and the second end. The cable gripping portion may include a protruding portion that extends from an inner surface of the body portion into the cable receiving portion, and the component engaging portion may include an engagement portion on an outer surface of the body portion. The protruding portion may include a plurality of protruding structures in a first pattern, and the component engaging portion may include a plurality of engagement structures in a second pattern, and the first pattern may differ from the second pattern such that at least one of the protruding structures is misaligned relative to the plurality of engagement structures. Each of the plurality of protruding structures may be structurally configured to engage a groove in an outer surface of a jacket of a fiber optic cable, and each of the plurality of engagement structures may be structurally configured to receive a gripping portion of a component of a fiber optic network, such that the body portion is configured to prevent axial movement of a cable received in the cable receiving portion relative to the component in response to a pulling force on the cable. The body portion may be structurally configured to augment an outer diameter of a cable received in the cable receiving portion such that the cable is configured to be coupled with the component at an opening of the component having a diameter that is larger than an outer diameter of the cable and substantially matches the augmented outer diameter so as to provide enhanced attachment of the cable to the component.

In some embodiments of the aforementioned cable adapters, the bore of the cable receiving portion may be configured to receive a cable in a friction fit or interference fit.

In some embodiments of the aforementioned cable adapters, the body portion may be structurally configured to concurrently engage the cable and the opening of the component to physically secure the cable to the component.

In some embodiments of the aforementioned cable adapters, the body portion may be structurally configured to augment an outer diameter of a cable received in the cable receiving portion such that the cable is configured to be coupled with a distribution box, a distribution panel, or an enclosure having the opening.

In some embodiments of the aforementioned cable adapters, the first pattern may position the respective protruding structures with spacing along the longitudinal axis that may differ relative to spacing of the engagement structures along the longitudinal axis according to the second pattern.

According to various aspects of the disclosure, a cable adapter may include a body portion configured to include a cable receiving portion and a cable gripping portion. The cable receiving portion may include a longitudinal bore extending from a first end of the body portion to a second end of the body portion such that the body portion may have a substantially C-shaped cross-sectional shape, the cable receiving portion may be configured to receive a portion of a cable from a lateral side of the body portion, and the cable gripping portion may include a protruding portion that extends from an inner surface of the body portion into the cable receiving portion. The cable gripping portion may be structurally configured to engage a grooved portion of an outer surface of a jacket of a cable, and the body portion may be configured to receive a gripping portion of a component of a telecommunications network, such that the body portion is configured to prevent axial movement of a cable received in the cable receiving portion relative to the component in response to a pulling force on the cable. The body portion may be structurally configured to augment an outer diameter of a cable received in the cable receiving portion such that the cable is configured to be coupled with the component at an opening of the component having a diameter that is larger than an outer diameter of the cable so as to provide enhanced attachment of the cable to the component.

In some embodiments of the aforementioned cable adapters, the bore of the cable receiving portion may be configured to receive a cable in a friction fit or interference fit.

In some embodiments of the aforementioned cable adapters, the body portion may be structurally configured to concurrently engage the cable and the opening of the component to physically secure the cable to the component.

In some embodiments of the aforementioned cable adapters, the body portion may be structurally configured to augment an outer diameter of a cable received in the cable receiving portion such that the cable is configured to be coupled with a distribution box, a distribution panel, or an enclosure having the opening.

In some embodiments of the aforementioned cable adapters, the cable gripping portion may be structurally configured to engage a grooved portion of an outer surface of a jacket of a cable, and wherein the body portion is configured to receive a gripping portion of a component of a telecommunications network.

In some embodiments of the aforementioned cable adapters, the cable gripping portion may include a protruding portion that extends from an inner surface of the body portion into the cable receiving portion. In some aspects, the body portion may include a component engaging portion, the component engaging portion may include an engagement portion on an outer surface of the body portion, and the protruding portion may include a plurality of protruding structures in a first pattern, and wherein the component engaging portion comprises a plurality of engagement structures in a second pattern. In some aspects, the first pattern may position the respective protruding structures with spacing along the longitudinal axis that may differ relative to spacing of the engagement structures along the longitudinal axis according to the second pattern. In some aspects, each of the plurality of protruding structures may be structurally configured to engage a grooved portion of an outer surface of a jacket of a fiber optic cable, and wherein each of the plurality of engagement structures is structurally configured to receive a gripping portion of the component.

According to various aspects of the disclosure, a cable adapter may include a body portion configured to include a cable receiving portion and a cable gripping portion. The cable receiving portion may include a longitudinal bore extending from a first end of the body portion to a second end of the body portion, and the cable receiving portion may be configured to receive a portion of a cable from a lateral side of the body portion. The body portion may be structurally configured to engage a grooved portion of an outer surface of a jacket of a cable, and wherein the body portion is configured to receive a gripping portion of a component of a telecommunications network, such that the body portion is structurally configured to augment an outer diameter of a cable received in the cable receiving portion such that the cable is configured to be coupled with the component at an opening of the component having a diameter that is larger than an outer diameter of the cable so as to provide enhanced attachment of the cable to the component.

In some embodiments of the aforementioned cable adapters, the bore of the cable receiving portion may be configured to receive a cable in a friction fit or interference fit.

In some embodiments of the aforementioned cable adapters, the body portion may be structurally configured to concurrently engage the cable and the opening of the component to physically secure the cable to the component.

In some embodiments of the aforementioned cable adapters, the body portion may be structurally configured to augment an outer diameter of a cable received in the cable receiving portion such that the cable is configured to be coupled with a distribution box, a distribution panel, or an enclosure having the opening.

In some embodiments of the aforementioned cable adapters, the cable gripping portion may be structurally configured to engage a grooved portion of an outer surface of a jacket of a cable, and wherein the body portion is configured to receive a gripping portion of a component of a telecommunications network.

In some embodiments of the aforementioned cable adapters, the cable gripping portion may include a protruding portion that extends from an inner surface of the body portion into the cable receiving portion. In some aspects, the body portion may include a component engaging portion, the component engaging portion may include an engagement portion on an outer surface of the body portion, and the protruding portion may include a plurality of protruding structures in a first pattern, and wherein the component engaging portion comprises a plurality of engagement structures in a second pattern. In some aspects, the first pattern may position the respective protruding structures with spacing along the longitudinal axis that may differ relative to spacing of the engagement structures along the longitudinal axis according to the second pattern. In some aspects, each of the plurality of protruding structures may be structurally configured to engage a grooved portion of an outer surface of a jacket of a fiber optic cable, and wherein each of the plurality of engagement structures is structurally configured to receive a gripping portion of the component.

In some embodiments of the aforementioned cable adapters, the body portion may be configured to prevent axial movement of a cable received in the cable receiving portion relative to the component in response to a pulling force on the cable.

In some embodiments of the aforementioned cable adapters, the body portion may have a substantially C-shaped cross-sectional shape.

### BRIEF DESCRIPTION OF THE DRAWINGS

Further advantages and features of the present disclosure will become apparent from the following description and the accompanying drawings, to which reference is made.

FIG. 1 is a line representation of portions of a cable environment in which assorted embodiments can be practiced.

FIG. 2 is a line representation of portions of a cable assembly that can be employed in the environment of FIG. 1.

FIG. 3 is a line representation of portions of a cable assembly that utilizes a sleeve adapter system in accordance with various embodiments of this disclosure.

FIG. 4 is a perspective view of portions of a sleeve adapter system employed in accordance with various embodiments of this disclosure.

FIG. 5 is a perspective view of a sleeve adapter system that can be utilized in the cable assembly of FIG. 3 in accordance with various embodiments of this disclosure.

FIG. 6 displays assorted views of a sleeve that can be utilized in the cable assembly of FIG. 3 in accordance with various embodiments of this disclosure.

FIG. 7 illustrates assorted views of a sleeve that can be utilized in the cable assembly of FIG. 3 in accordance with various embodiments of this disclosure

### DETAILED DESCRIPTION

Embodiments provide an adapter sleeve that is structurally configured to secure a cable in a cable opening of a network component to facilitate the use of a cable that is not designed to engage the cable opening and enable adaptation of use of the cable in different network components.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The proliferation of wired signal connections has provided digital networks that allow sophisticated communications. Larger volumes of wired connections corresponds with increased amounts of interconnections that distribute cables to various sites, terminals, and interfaces. The use of a variety of cable sizes and capabilities can provide efficient installation with ample signal communication performance. Yet, using a variety of different cable sizes can present some challenges, particularly in integration with physical components that facilitate distribution of cabling. Hence, various embodiments are generally directed to an adapter system for cabling that allows a technician to efficiently integrate cabling into network distribution components.

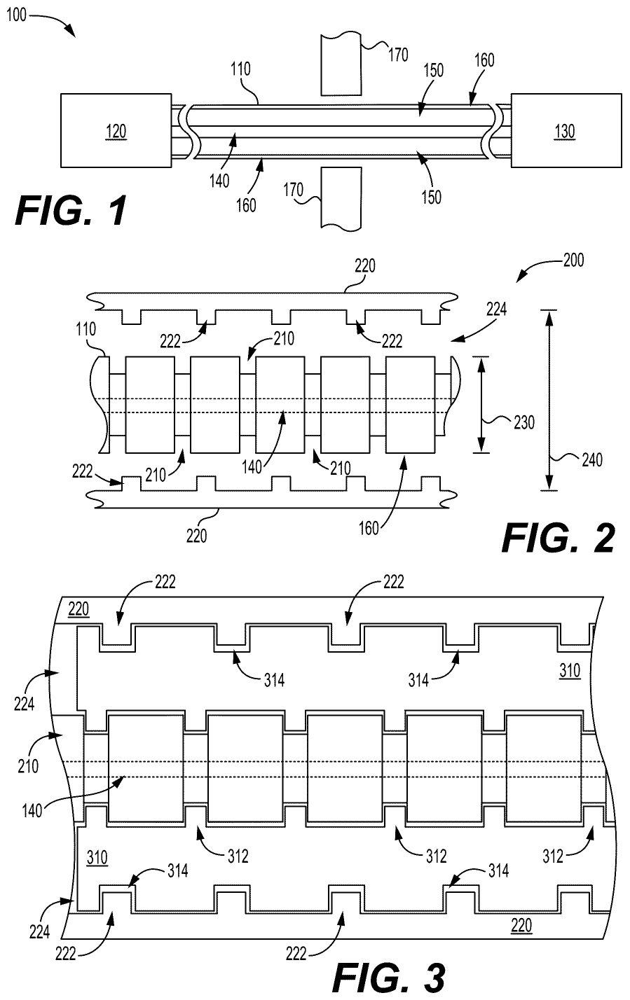

Assorted aspects of an adapter system are displayed in FIGS. 1-7. In FIG. 1, a line representation of a cable environment 100 is shown in which embodiments of an adapter system can be practiced. One or more cables 110 can provide at least one stable signal pathway from a source 120 to a destination 130. A cable 110 can house one or more signal conductors 140, such as an electrically conducting wire or optical conduit, that provide two-way communication between the source 120 and destination 130. The cable conductor(s) 140 can be surrounded by one or more protective layers, such as an insulating layer 150 and outer jacket 160 shown in FIG. 1.

In some embodiments, one or more shielding and/or reinforcing materials are positioned within the outer jacket 160 to contribute, for example, the consistent signal carrying performance of a constituent conductor 140 and increase cable installation efficiency. Some cable 110 installation situations pass the cable 110 through a wall 170, housing, or aperture, which can present challenges over time if the cable 110 is not physically secure. For instance, environmental conditions, such as wind and rain, along with encountered events, such as pulling and pushing on the cable 110, can jeopardize the integrity of the cable 110, conductor 140, and signal pathway provided by the cable 110. Thus, physically securing a cable 110 can be paramount to reliable cable operation over time.

FIG. 2 illustrates portions of a cable assembly 200 that may be employed in a cable environment, such as environment 100 of FIG. 1, to increase the physical retention of a cable 110 over time. The cable 110 has a contoured outer jacket 160 that has a number of grooves 210 that aid in, for example, flexibility of the cable 100, and physical engagement and retention of the cable 110. It is noted that the cable grooves 210 are not limited to a particular configuration and can be any size, shape, and position. For instance, a groove 210 may be a circumferential recess with a uniform cross-sectional shape or a spiral recess with a varying cross-sectional size and/or shape.

The presence of the cable grooves 210 can provide heightened surface area and greater numbers of edges compared to a smooth outer jacket 160. As such, the contoured cable 110 has greater slip resistance, along the cable's longitudinal axis, than a smooth outer jacket 160. The cable grooves 210, additionally, can allow for greater physical retention with a network component 220, such as a cassette, box, housing, panel, or other interface. The network component 220 can have a cable gripping portion 222, for example, one or more protrusions, that are configured with a size and shape to engage and secure at least one groove 210 of the cable 110.

While engagement and retention of a cable 110 can be aided by the presence of the grooves 210, the configuration of the protrusions 222 and cable opening 224 in the network component 220 must match the groove 210 configuration to provide enhanced physical interaction. That is, the size, shape, and position of the assorted protrusions 222 are preferably similar to the size, shape, and position of the assorted grooves 210 to allow the protrusions 222 to partially, or completely, fill the grooves 210 and contact the groove edges to capture the cable 110 and prevent inadvertent cable 110 movement over time.

It is noted that the configuration of the respective protrusions 222 or grooves 210 can be characterized as a pattern that comprises the size, shape, and spacing of the assorted aspects along the cable 110 or component 220. Hence, the respective patterns of the protrusions 222 and grooves 210 must position a protrusion 222 in a groove 210 to achieve maximum physical retention performance. When the pattern configurations of the protrusions 222 do not match with the grooves 210, the surface area contact between the component 220 and cable 110 may be reduced, which can provide worse physical retention over time than a cable with no grooves 210. Accordingly, it is an emphasis of various embodiments of a cable assembly 200 to provide matching groove 210 and protrusion 222 patterns.

In the example situation illustrated in FIG. 2, the cable 110 is not large enough to engage the component protrusions 222. That is, the diameter 230 of the cable 110 is not large enough to fill the cable opening 224 of the component 220 to allow physical contact of the protrusions 222 with the grooves 210. In a situation where the patterns of the protrusions 222 and grooves 210 match, the cable diameter 230 must be of adequate size to allow the cable 110 to be properly retained in the cable opening 224. Furthermore, if the cable 110 had a larger diameter 240 that brought the grooves 210 into position proximal the protrusions 222, the respective patterns of the protrusions 222 and grooves 210 must align to provide proper physical retention of the cable 110. Hence, to fulfill the retention potential of the cable 110, the cable size, cable opening size, protrusion pattern, and groove pattern must all correlate.

In practice, matching the cable diameter and groove pattern with a cable opening and protrusion pattern can be difficult. For instance, an existing cable box, or interface, may have a single cable opening that has a size and protrusion pattern that matches one cable 110, but not a secondary cable 110 that is later installed. Another example situation can involve insufficient space to install, or alter, a network component 220 configured with an opening 224 and protrusion pattern that mates properly to a cable 110 that is sized for the installation site. As a result, a variety of installation, management, and alteration for a cable distribution network can result in a mismatch between a cable opening 224 and cable 110.

Accordingly, various embodiments provide a cable sleeve that adapts dissimilar cable/opening configurations to provide optimal physical engagement and retention. FIGS. 3-7 respectively illustrate assorted aspects of a sleeve adapter system 300 that can increase the quality of physical retention of a contoured cable 110. FIG. 3 is a line representation of portions of the sleeve adapter system 300 engaging a network component cable opening 224 in accordance with various embodiments. It is noted that the pattern of grooves 210 of the cable 110 is dissimilar from the pattern of protrusions 222 present on a network component 220.

Such dissimilarity in the position of the protrusions 222 relative to the grooves 210 may, in some embodiments, correspond with matching positions along the longitudinal axis of the cable 110 while having differently sized, or shaped, protrusions 222 relative to the respective grooves 210. Thus, for a pattern of protrusions 222 to match a pattern of grooves 210, the position, size, and shape, for example, of each groove 210 must match each protrusion 222. And, even if the patterns of the respective grooves 210 match the protrusions 222, the diameter 230 of the cable 110 must match the diameter 240 of the cable opening 224 for the cable 110 to be securely engaged and retained.

In view of situations where a grooved cable 110 has a pattern, and/or diameter 230, that is dissimilar from the protrusion 222 pattern, and/or opening diameter 240, various embodiments insert a sleeve adapter 310 into the cable opening 224 to fill the difference between the cable diameter 230 and the opening diameter 240 while adapting the groove 210 pattern to the protrusion 222 pattern. The sleeve 310 can be constructed of any materials, such as, for example, a polymer, metal, ceramic, or rubber, that provide a consistent, size and shape that provides both protrusions 312 that match the grooves 210 and a component engaging portion 314, for example, grooves, that match the protrusions 222.

While the sleeve 310 is shown in FIG. 3 separated from the cable 110 and network component 220, such arrangement is not required and is present to clarify the individual features of the various aspects of the system 300. Hence, embodiments of the sleeve 310 may physically contact the network component 220 and cable 110.

It is contemplated, in some embodiments, that the sleeve 310 provides matching patterns for protrusions 312 and grooves 314. However, such matching patterns is not required as a single sleeve 310 can present a different protrusion 312 pattern compared to a groove 314 pattern in order for the cable grooves 210 and opening protrusions 222 to each be engaged by concurrently providing separate patterns that match and occupy the respective grooves 210 and surround the respective protrusions 222. The sleeve 310 may be configured, in some embodiments, as a unitary structure with sufficient pliability to slide around the cable 110 without moving the cable 110. Other embodiments configure the sleeve 310 as a continuous ring structure that slides onto the cable 110 by passing the cable 110 through a central sleeve 310 aperture.

Multiple sleeves may be nested, which provides modularity and an ability to adapt to a variety of different cable 110 and cable opening 224 arrangements without a large number of different sleeves 310. For instance, in the event a first sleeve 310 has a protrusion 312 pattern that matches cable grooves 210, but does not match an opening protrusion 222 pattern, a second sleeve (not shown) can be positioned to engage the first sleeve 310 to fill the cable opening 224 while providing a groove 314 pattern that matches the opening protrusions 222. The ability to provide different sizes and patterns with one or more sleeves 310/320 can provide efficient and optimized installation that results in secure physical retention of the cable 110 in the cable opening 224.

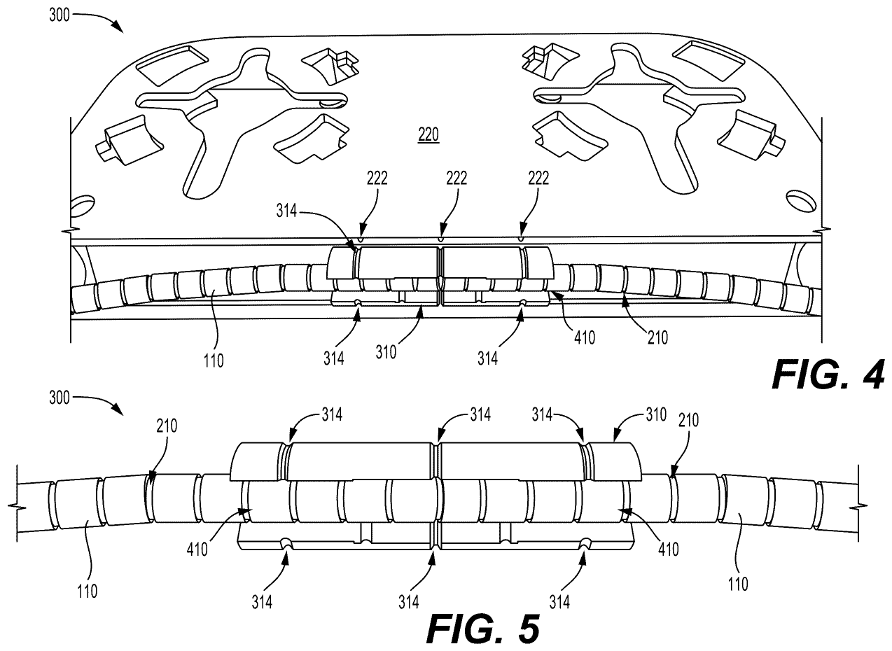

FIG. 4 illustrates a perspective view of portions of a sleeve adapter system 300 operated in accordance with various embodiments. The network component 220 presents a cable opening 224 that is occupied by a cable 110 as well as a sleeve 310 that fills the space between the cable diameter and the size of the opening 224, as shown. It is noted that less than the entirety of the cable opening 224 has cantilevered protrusions 222 each extending into the opening 224, towards the cable 110. It is further noted that protrusions 222 may be present on opposite sides of the opening 224 or on a single lateral side of the opening 224.

The use of the sleeve 310 allows the grooved cable 110 with a relatively small diameter 230 to be secured within the cable opening 224 that is larger than the cable 110. In other words, even if the cable grooves 210 had a matching pattern as the component protrusions 222, the size of the cable 110 without the sleeve 310 would not allow for secure physical retention of the cable 110 within the cable opening 224. Accordingly, one or more sleeves 310 can be inserted onto the cable 110 with protrusions 312 that engage the cable grooves 210 to provide an ability to contact and secure the cable 110 to the opening protrusions 222 via the sleeve grooves 314.

To provide efficient installation, alteration, and removal of a sleeve 310, a cable receiving portion 410, for example, a continuous bore, channel, or gap, is present, as shown. The gap 410 is configured to allow manual installation, and removal, of the sleeve 310 with respect to the cable 110 from a lateral side of the cable 110. It is contemplated that the sleeve gap 410 has a width, as measured orthogonal to the longitudinal axis of the sleeve 310 and cable 110, that is less than the diameter 230 of the cable 110, which promotes secure physical engagement and retention of the sleeve 310 once installed. With the gap 410 being less than the cable diameter 230, the material of the sleeve 310 must flex, bend, or otherwise temporarily move during installation or removal from the cable 110.

FIG. 5 illustrates a perspective view of portions of a grooved cable sleeve adapter system 300 with a sleeve 310 installed onto a cable 110 in accordance with various embodiments. The view of FIG. 5 further shows the assorted features of the cable 110 and sleeve 310 with the sleeve 310 inserted onto the cable 110 in preparation for installation into a component cable opening 224, as displayed in FIG. 4. Specifically, FIG. 5 conveys how the sleeve grooves 314 have a different pattern than the cable grooves 210 and how the sleeve gap 410 has a smaller width than the diameter of the cable 110.

In some embodiments, the sleeve gap 410 can be used to secure separate secondary sleeve (not shown) to an existing sleeve 310. For instance, a secondary sleeve can occupy an existing, installed sleeve gap 410 and continuously surround portions of the existing sleeve to provide an additional sleeve size and, in some embodiments, a different outer sleeve groove 314 pattern. The ability to employ multiple separate sleeves 310 concurrently provides a diverse range of installation configurations that can adapt many different cable sizes, cable groove patterns, cable opening sizes, and cable opening protrusion patterns to efficiently produce a secure physical connection with a cable 110 that is smaller than the cable opening 224 in which it is being installed.

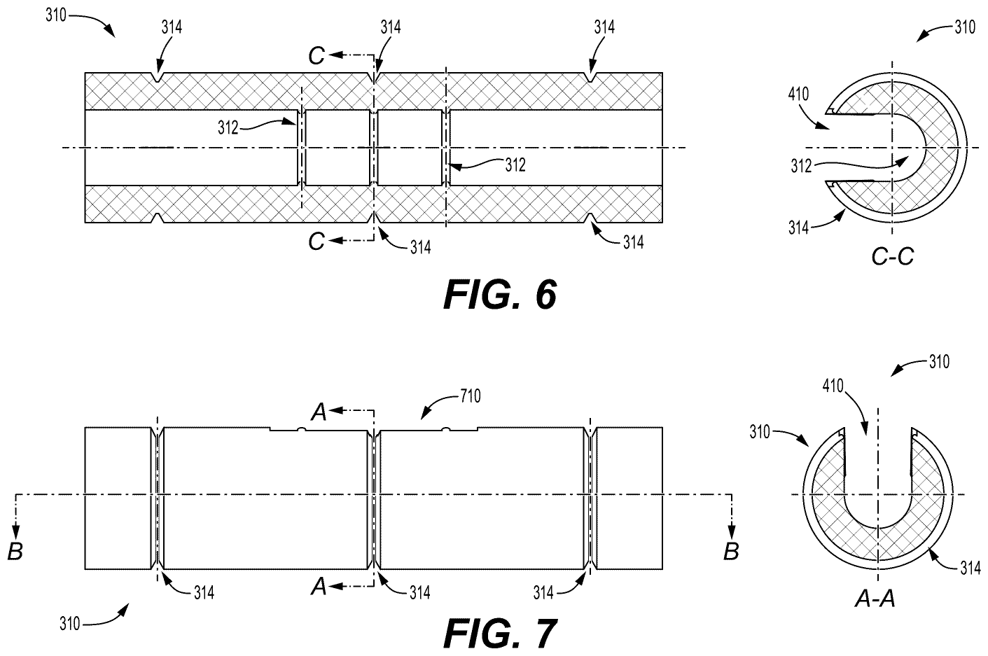

FIGS. 6 and 7 respectively illustrates different views of a cable sleeve adapter 310 that can be incorporated into the cable assembly of FIG. 2 and the cable environment 100 of FIG. 1 in accordance with various embodiments. FIG. 6 conveys cross-sectional views of a sleeve 310 that individually, and collectively, show how the sleeve protrusions 312 are arranged and positioned relative to sleeve grooves 314. The C-C cross-section shown in FIG. 6 further conveys the non-limiting physical relationship of the sleeve protrusions 312 to the externally-facing sleeve grooves 314.

FIG. 7 conveys a top plan view and corresponding cross-sectional view of the sleeve 310 that further illustrate how the sleeve grooves 314 can continuously extend with a uniform size and shape around the entire periphery of the sleeve 310. The cross-sectional view of FIG. 7 illustrates how the sleeve gap 410 can continuously extend into the sleeve 310 to form a c-notch including linear and curvilinear sidewalls.

The top view of the sleeve 310 shown in FIG. 7 further illustrates a non-limiting recess portion 710 that can allow for one or more separate retention features to aid the sleeve's engagement and retention on the cable 110. For instance, the recess portion 710 may contribute to the placement and retention of a strap, tie, or band that can apply continuous inward force onto the sleeve 310 to promote secure positioning on a cable 110.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A cable adapter structurally configured to augment a cable diameter to enhance attachment with a component comprising:
a body portion configured to include a cable receiving portion, a cable gripping portion, and a component engaging portion;
wherein the cable receiving portion comprises a U-shaped longitudinal bore extending from a first end of the body portion to a second end of the body portion such that the body portion has a substantially C-shaped cross-sectional shape;
wherein the cable receiving portion is configured to receive a portion of a cable from a lateral side of the body portion such that the cable is permitted to extend beyond at least one of the first end and the second end;
wherein the cable gripping portion comprises a protruding portion that extends from an inner surface of the body portion into the cable receiving portion;
wherein the component engaging portion comprises an engagement portion on an outer surface of the body portion;
wherein the protruding portion comprises a plurality of protruding structures in a first pattern, and wherein the component engaging portion comprises a plurality of engagement structures in a second pattern;
wherein the first pattern differs from the second pattern such that at least one of the protruding structures is misaligned relative to the plurality of engagement structures;
wherein each of the plurality of protruding structures is structurally configured to engage a groove in an outer surface of a jacket of a fiber optic cable, and wherein each of the plurality of engagement structures is structurally configured to receive a gripping portion of a component of a fiber optic network, such that the body portion is configured to prevent axial movement of a cable received in the cable receiving portion relative to the component in response to a pulling force on the cable; and
wherein the body portion is structurally configured to augment an outer diameter of a cable received in the cable receiving portion such that the cable is configured to be coupled with the component at an opening of the component having a diameter that is larger than an outer diameter of the cable and substantially matches the augmented outer diameter so as to provide enhanced attachment of the cable to the component.

2. The cable adapter of claim 1, wherein the bore of the cable receiving portion is configured to receive a cable in a friction fit or interference fit.

3. The cable adapter of claim 1, wherein the body portion is structurally configured to concurrently engage the cable and the opening of the component to physically secure the cable to the component.

4. The cable adapter of claim 1, wherein the body portion is structurally configured to augment an outer diameter of a cable received in the cable receiving portion such that the cable is configured to be coupled with a distribution box, a distribution panel, or an enclosure having the opening.

5. The cable adapter of claim 1, wherein the first pattern positions the respective protruding structures with spacing along the longitudinal axis that differs relative to spacing of the engagement structures along the longitudinal axis according to the second pattern.

6. A cable adapter structurally configured to augment a cable diameter to enhance attachment with a component comprising:
a body portion configured to include a cable receiving portion and a cable gripping portion;
wherein the cable receiving portion comprises a longitudinal bore extending from a first end of the body portion to a second end of the body portion such that the body portion has a substantially C-shaped cross-sectional shape;
wherein the cable receiving portion is configured to receive a portion of a cable from a lateral side of the body portion;
wherein the cable gripping portion comprises a protruding portion that extends from an inner surface of the body portion into the cable receiving portion;
wherein the cable gripping portion is structurally configured to engage a grooved portion of an outer surface of a jacket of a cable, and wherein the body portion is configured to receive a gripping portion of a component of a telecommunications network, such that the body portion is configured to prevent axial movement of a cable received in the cable receiving portion relative to the component in response to a pulling force on the cable; and
wherein the body portion is structurally configured to augment an outer diameter of a cable received in the cable receiving portion such that the cable is configured to be coupled with the component at an opening of the component having a diameter that is larger than an outer diameter of the cable so as to provide enhanced attachment of the cable to the component.

7. The cable adapter of claim 6, wherein the bore of the cable receiving portion is configured to receive a cable in a friction fit or interference fit.

8. The cable adapter of claim 6, wherein the body portion is structurally configured to concurrently engage the cable and the opening of the component to physically secure the cable to the component.

9. The cable adapter of claim 6, wherein the body portion is structurally configured to augment an outer diameter of a cable received in the cable receiving portion such that the cable is configured to be coupled with a distribution box, a distribution panel, or an enclosure having the opening.

10. The cable adapter of claim 6, wherein the cable gripping portion is structurally configured to engage a grooved portion of an outer surface of a jacket of a cable, and wherein the body portion is configured to receive a gripping portion of a component of a telecommunications network.

11. The cable adapter of claim 6, wherein the cable gripping portion comprises a protruding portion that extends from an inner surface of the body portion into the cable receiving portion.

12. The cable adapter of claim 11, wherein the body portion further comprises a component engaging portion;
wherein the component engaging portion comprises an engagement portion on an outer surface of the body portion; and
wherein the protruding portion comprises a plurality of protruding structures in a first pattern, and wherein the component engaging portion comprises a plurality of engagement structures in a second pattern.

13. The cable adapter of claim 12, wherein the first pattern positions the respective protruding structures with spacing along the longitudinal axis that differs relative to spacing of the engagement structures along the longitudinal axis according to the second pattern.

14. The cable adapter of claim 12, wherein each of the plurality of protruding structures is structurally configured to engage a grooved portion of an outer surface of a jacket of a fiber optic cable, and wherein each of the plurality of engagement structures is structurally configured to receive a gripping portion of the component.

15. A cable adapter structurally configured to augment a cable diameter to enhance attachment with a component comprising:
a body portion configured to include a cable receiving portion and a cable gripping portion;
wherein the cable receiving portion comprises a longitudinal bore extending from a first end of the body portion to a second end of the body portion;
wherein the cable receiving portion is configured to receive a portion of a cable from a lateral side of the body portion;
wherein the body portion is structurally configured to engage a grooved portion of an outer surface of a jacket of a cable, and wherein the body portion is configured to receive a gripping portion of a component of a telecommunications network, such that the body portion is structurally configured to augment an outer diameter of a cable received in the cable receiving portion such that the cable is configured to be coupled with the component at an opening of the component having a diameter that is larger than an outer diameter of the cable so as to provide enhanced attachment of the cable to the component.

16. The cable adapter of claim 15, wherein the bore of the cable receiving portion is configured to receive a cable in a friction fit or interference fit.

17. The cable adapter of claim 15, wherein the body portion is structurally configured to concurrently engage the cable and the opening of the component to physically secure the cable to the component.

18. The cable adapter of claim 15, wherein the body portion is structurally configured to augment an outer diameter of a cable received in the cable receiving portion such that the cable is configured to be coupled with a distribution box, a distribution panel, or an enclosure having the opening.

19. The cable adapter of claim 15, wherein the cable gripping portion is structurally configured to engage a grooved portion of an outer surface of a jacket of a cable, and wherein the body portion is configured to receive a gripping portion of a component of a telecommunications network.

20. The cable adapter of claim 15, wherein the cable gripping portion comprises a protruding portion that extends from an inner surface of the body portion into the cable receiving portion.

21. The cable adapter of claim 20, wherein the body portion further comprises a component engaging portion;
wherein the component engaging portion comprises an engagement portion on an outer surface of the body portion; and
wherein the protruding portion comprises a plurality of protruding structures in a first pattern, and wherein the component engaging portion comprises a plurality of engagement structures in a second pattern.

22. The cable adapter of claim 21, wherein the first pattern positions the respective protruding structures with spacing along the longitudinal axis that differs relative to spacing of the engagement structures along the longitudinal axis according to the second pattern.

23. The cable adapter of claim 21, wherein each of the plurality of protruding structures is structurally configured to engage a grooved portion of an outer surface of a jacket of a fiber optic cable, and wherein each of the plurality of engagement structures is structurally configured to receive a gripping portion of the component.

24. The cable adapter of claim 15, wherein the body portion is configured to prevent axial movement of a cable received in the cable receiving portion relative to the component in response to a pulling force on the cable.

25. The cable adapter of claim 15, wherein the body portion has a substantially C-shaped cross-sectional shape.
